(19) United States
(12) Patent Application Publication
(10) Pub. No.: US 2014/0285115 A1
(43) Pub. Date: Sep. 25, 2014

(54) MULTI-CHANNEL DRIVER AND ILLUMINATING DEVICE

(71) Applicants: Michele Menegazzi, Paese (IT); Zeke Wei, Shenzhen (CN); Yuping Zhang, Shenzhen (CN); XiHe Zhuang, Shenzhen (CN)

(72) Inventors: Michele Menegazzi, Paese (IT); Zeke Wei, Shenzhen (CN); Yuping Zhang, Shenzhen (CN); XiHe Zhuang, Shenzhen (CN)

(73) Assignee: OSRAM GMBH, Muenchen (DE)

(21) Appl. No.: 14/342,798

(22) PCT Filed: Jul. 25, 2012
(86) PCT No.: PCT/EP2012/064566

§ 371 Date: May 16, 2014

(30) Foreign Application Priority Data
Sep. 5, 2011 (CN) 201110281028.3

(51) Int. Cl. H05B 33/08

(52) U.S. Cl. CPC H05B 33/0809
USPC 315/307

(57) ABSTRACT

A multi-channel driver for driving an illuminating unit includes: a plurality of output channels for coupling with the illuminating unit; a power supply unit for supplying a driving current; a current distributing unit, which includes at least one current distributing circuit, wherein the at least one current distributing circuit includes two output channels respectively, and distributes the driving current provided by the power supply unit to the two output channels; a current detecting unit for detecting the output current output by the output channels, wherein the unit is configured with at least one current detecting circuit for the two output channels, and a control unit, wherein the control unit regulates the driving current according to the output current detected by the at least one current detecting circuit of the current detecting unit, to maintain constant output current in the output channels.

### RELATED APPLICATIONS

The present application is a national stage entry according to 35 U.S.C. §371 of PCT application No.: PCT/EP2012/064566 filed on Jul. 25, 2012, which claims priority from Chinese application No.: 201110281028.3 filed on Sep. 5, 2011, and is incorporated herein by reference in its entirety.

### TECHNICAL FIELD

Various embodiments relate to the technical field of illumination, and in particular, to a multi-channel driver for a illuminating unit. Various embodiments further relate to an illuminating device.

### BACKGROUND

At present, in the multi-channel driving circuit for driving a light emitting diode (LED), a DC/DC converter is arranged in each channel to ensure the normal operation of the LED. However, since one DC/DC converter must be arranged respectively in each channel, the multi-channel driving circuit is relatively complex as a whole. Moreover, since the DC/DC converter is still in the circuit even no load is coupled to the branch, the driving circuit has a low efficiency. Further, the multi-channel driving circuit leads to a high cost due to the complexity of itself.

### SUMMARY

Hereinafter, a brief summary of the present disclosure is given, so as to provide a basic understanding of some aspects of the present disclosure. It should be understood that the summary is not an exhaustive summary of the disclosure. The summary neither intends to determine the critical part or important part of the disclosure, nor intends to limit the scope of the disclosure. The object of the summary is only presenting some concepts in a brief form, which is used as a preamble of the detailed description that will be presented later.

Various embodiments provide a multi-channel driver for driving an illuminating unit, the multi-channel driver includes a plurality of output channels for coupling with the illuminating unit, wherein the multi-channel driver includes: a power supply unit for supplying a driving current; a current distributing unit, which includes at least one current distributing circuit, the at least one current distributing circuit includes two output channels respectively, and distributes the driving current provided by the power supply unit to the two output channels; a current detecting unit for detecting the output current output by the output channels, wherein the current detecting unit is configured with at least one current detecting circuit for the two output channels of the at least one current distributing circuit; and a control unit, the control unit regulates the driving current provided by the power supply unit according to the output current detected by the at least one current detecting circuit of the current detecting unit, so that the output current in the output channels is maintained constant. The multi-channel driver has a simple structure. Due to the simple structure, the fabrication cost thereof is low. Further, the multi-channel driver reduces the additional power consumption, and thus has a high efficiency.

Further, various embodiments provide an illuminating device, which includes the multi-channel driver according to the embodiment of the disclosure and an illuminating unit, wherein the illuminating unit is coupled to the output channel of the multi-channel driver, and obtains the operating current from the multi-channel driver.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 shows a dual-channel. LED driver in the prior art;

FIG. 2 shows a schematic block diagram of a multi-channel driver for driving an illuminating unit according to an embodi-ment of the present disclosure;

FIG. 3 shows a multi-channel driver for driving the illuminating unit according to an embodiment of the present disclosure;

FIG. 4 shows a multi-channel driver for driving the illuminating unit according to another embodiment of the present disclosure;

FIG. 5 shows a schematic structural diagram of a current distributing circuit of the multi-channel driver for driving the illuminating unit according to an embodiment of the present disclosure;

FIG. 6 shows a schematic structural diagram of a current detecting circuit of the multi-channel driver for driving the illuminating unit according to an embodiment of the present disclosure;

FIG. 7 shows a schematic structural diagram of a voltage detecting circuit of the multi-channel driver for driving the illuminating unit according to an embodiment of the present disclosure; and

FIG. 8 shows a circuit diagram of a specific example of the multi-channel driver for driving the illuminating unit according to an embodiment of the present disclosure.

### DETAILED DESCRIPTION

Hereinafter, the embodiments of the present disclosure will be described in combination with the drawings. In view of clearness and conciseness, not all the features of the practical embodiments are described in the description. However, it should be understood that many decisions specific to the embodiments need to be made during the development of any practical embodiments, so as to achieve the specific objects of the developer, and these decisions may be changed with the variation of the embodiments.

It should be further pointed out here that in the drawings, only the device structure closely related to the solution of the present disclosure is illustrated in the drawings, and other details having little relation with the present disclosure is omitted, so as to avoid making the present disclosure unclear due to unnecessary details.

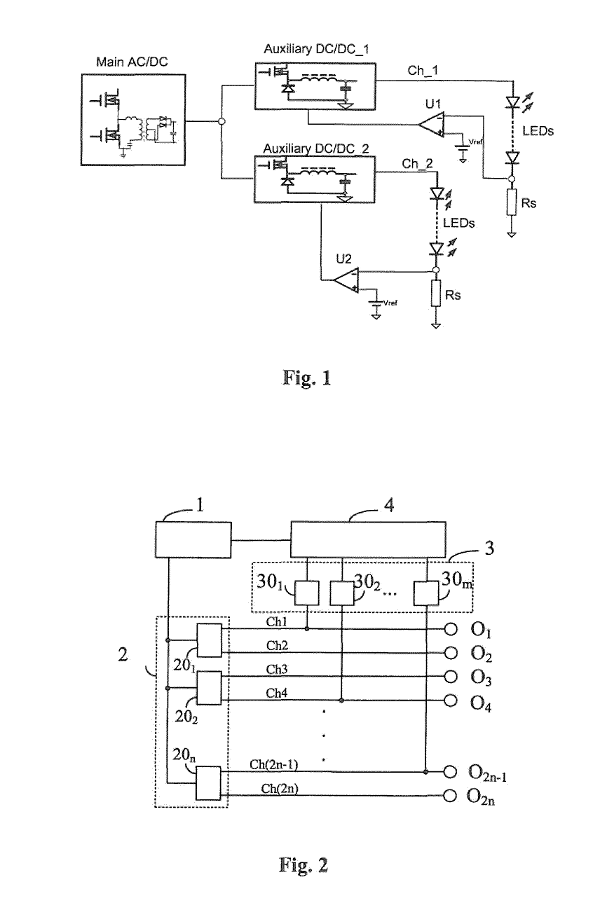

FIG. 1 schematically shows a multi-channel driver for driving an LED in the prior art. As shown in FIG. 1, the multi-channel driver comprises a main AC/DC converter, AC/DC, and two auxiliary DC/DC converters, DC/DC_{—}1 and DC/DC_{—}2. The main AC/DC converter provides the two auxiliary DC/DC converters, DC/DC_{—}1 and DC/DC_{—}2, with its output current via the output terminal thereof, and the auxiliary DC/DC converters, DC/DC_{—}1 and DC/DC_{—}2, provides the LED with driving current independently from each other on the output terminal thereof, i.e., the output channels Ch1 and Ch2. It should be pointed out that here the multi-channel driver in the prior art is described only with the example of the dual-channel driver. At present, in the prior art, in order to implement driving of the LED in the multichannel manner, it is required to arrange one DC/DC converter in each output terminal of the multi-channel driver.

Thus, it can be seen from FIG. 1 that the auxiliary DC/DC converter, which is arranged to ensure the reliable operation of the LEDs coupled to each channel of the multi-channel driver, may lead to complexity of the layout of the multi-channel driving circuit as a whole. Moreover, since the auxiliary DC/DC converter is always in the circuit, i.e., consumes certain amount of electric energy, even if no load is coupled in the branch, the driving circuit has a low efficiency. Moreover, the complexity of the layout of the multi-channel driver will necessarily lead to the defect of high cost.

Hereinafter, the multi-channel driver for the illuminating unit according to the embodiment of the present disclosure will be described in more detail in conjunction of the drawings. It should be understood that the present disclosure is not limited to the described embodiments because of the description referring to the drawings.

FIG. 2 shows a multi-channel driver for driving an illuminating unit according to an embodiment of the present disclosure. The multi-channel driver comprises a power supply unit 1 for providing driving current. It can be understood by those skilled in the art that the power supply unit 1 mentioned in the context of the present application may be a common power supply module or power supply chip etc. in the technical field, such as a full bridge circuit or a half bridge circuit.

The multi-channel driver comprises a current distributing unit 2. The current distributing unit comprises at least one current distributing circuit 20₁, 20₂, . . . , 20ₙ, wherein n is natural number. The at least one current distributing circuit 20₁, 20₂, . . . , 20ₙ comprises two output channels (Ch1, Ch2), (Ch3, Ch4), . . . , (Ch(2n−1), Ch(2n)) respectively, and distributes the driving current to the two output channels (Ch1, Ch2), (Ch3, Ch4), . . . , (Ch(2n−1), Ch(2n)) respectively. The multi-channel driver comprises a current detecting unit 3 for detecting the output current output by the output channels (Ch1, Ch2), (Ch3, Ch4), . . . , (Ch(2n−1), Ch(2n)). At least one current detecting circuit 30₁, 30₂, . . . , 30ₘ is arranged in the current detecting unit 3 for the two output channels (Ch1, Ch2), (Ch3, Ch4), . . . , (Ch(2n−1), Ch(2n)) of the at least one current distributing circuit 20₁, 20₂, . . . , 20ₙ, wherein m is natural number and n≦m≦2n.

In another words, the number of the current detecting circuit 30₁, 30₂, . . . , 30_{M}, comprised in the current detecting unit 3 is dependent on the number of performing the current detection for the output channels (Ch1, Ch2), (Ch3, Ch4), . . . , (Ch(2n−1), Ch(2n)). Only one current detecting circuit may be arranged for any one of the two output channels (Ch1, Ch2), (Ch3, Ch4), . . . , (Ch(2n−1), Ch(2n)) of each of the current distributing circuits 20₁, 20₂, . . . , 20ₙ, i.e., totally n current detecting circuits 30₁, 30₂, . . . , 30_{M}, are arranged. Alternatively, in order to achieve a more precise regulation of the output current of the output channel, more current detecting circuits may be required, thus it is possible to arrange one current detecting circuit respectively for two output channels (Ch1, Ch2), (Ch3, Ch4), . . . , (Ch(2n−1), Ch(2n)) of each of the current distributing circuits 20₁, 20₂, . . . , 20ₙ, i.e., totally 2n current detecting circuits 30₁, 30₂, . . . , 30ₘ. In other words, the maximum number of the current detecting circuits 30₁, 30₂, . . . , 30ₘ, is twice of the number of the current distributing circuits 20₁, 20₂, . . . , 20ₙ. For the sake of clearness, the schematic diagram with 2n current distributing circuits 20₁, 20₂, . . . , 20ₙ is not illustrated. According to the practical requirements, it is certainly possible to select one or more current distributing circuits therefrom to perform current detection for both of the outputs, which will not be described in detail.

The multi-channel driver further comprises a control unit 4. The control unit 4 regulates the driving current provided by the power supply unit 1 according to the output current detected by the at least one current detecting circuit 30₁, 30₂, . . . , 30ₘ, of the current detecting unit 3, so that the output current in the output channels (Ch1, Ch2), (Ch3, Ch4), . . . , (Ch(2n−1), Ch(2n)) is maintained constant.

In FIG. 2, the reference signs O₁, O₂, . . . , O₂ₙ indicate the output terminal of the corresponding current distributing circuit, and the output terminal is coupled to the illuminating unit driven by the multi-channel driver (not shown).

Because the complex DC/DC circuit is omitted, especially in the case of the multi-channel, the multi-channel driver has a simple structure. Due to the simple structure, the fabrication cost is low. Moreover, when no illuminating unit is coupled to the output channel, no current is consumed in the output channel, so that the additional power consumption in the multi-channel driver is reduced. Thus, the efficiency of the multi-channel driver is further increased.

Hereinafter, various alternatives of the multi-channel driver shown in FIG. 2 will be described.

### First Alternative Embodiment

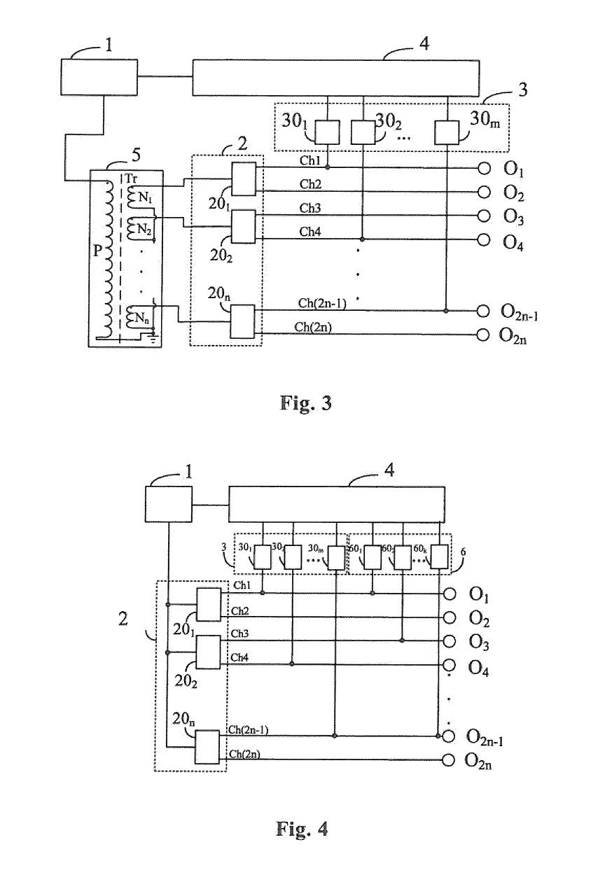

As can be seen from FIG. 3, the present alternative embodiment is a variation of the embodiment shown in FIG. 2. It should be pointed out that the description of the parts having the same function and effectiveness as that in FIG. 2 is omitted for conciseness.

The multi-channel driver further comprises a input stage 5, the input stage 5 is arranged in series between the power supply unit 1 and the current distributing unit 2, and is adapted to convert the driving current provided by the power supply unit 1 to one or more input current for the current distributing unit.

One or more input current for the current distributing unit should be understood here as follows: the number of the input current provided by the input stage 5 for the current distributing unit is dependent on the number of the at least one current distributing circuit comprised in the current distributing unit. For example, the input stage 5 may be configured so that one input current is provided for each current distributing circuit. According to the teach of the present disclosure, those skilled in the art may adjust and modify the input stage 5 appropriately according to the requirements of the application.

In a specific implementation, the input stage 5 may comprise a transformer Tr. In the simplest situation, the transformer Tr comprises a primary winding P and a plurality of secondary windings N₁, N₂, . . . , Nₙ, and the number of the secondary windings N₁, N₂, . . . , Nₙ equals to the number of the at least one current distributing circuit 20₁, 20₂, . . . , 20ₙ, Each of the secondary windings N₁, N₂, . . . , Nₙ is coupled to the input terminal of one of the current distributing circuits 20₁, 20₂, . . . , 20ₙ (as shown in FIG. 3). In this simplest situation, the number of the secondary windings equals to the number of the current distributing circuits. Certainly it is not excluded that according to the requirements of the operation of the multi-channel driving circuit, some components such as resistor, capacitor, etc. may be added or removed appropriately, or the coupling relation as shown may be modified appropriately, etc., so that the operation parameters of the multi-channel driver according to the embodi-ment of the present disclosure match the requirements of a specific application, which will not be described one by one any more.

### Second Alternative Embodiment

As can be seen from FIG. 4, the present alternative embodiment is another variation of the embodiment shown in FIG. 2. It should be pointed out that the description of the parts having the same function and effectiveness as that in FIG. 2 is omitted for conciseness.

The multi-channel driver further comprises a voltage detecting unit 6. The voltage detecting unit 6 is configured with at least one voltage detecting circuit 60₁, 60₂, . . . , 60ₖ for the two output channels (Ch1, Ch2), (Ch3, Ch4), . . . , (Ch(2n−1), Ch(2n)) of the at least one current distributing circuit 20₁, 20₂, . . . , 20ₙ, wherein k is natural number and n≦k≦2n. The control unit 4 regulates the driving current supplied by the power supply unit 1 according to the voltage on two terminals of the illuminating unit detected by the at least one voltage detecting circuit 601t 602, 60k of the voltage detecting unit 6, so that the voltage on two terminals of the illuminating unit is maintained to not exceed a predetermined threshold.

In other words, the number of the voltage detecting circuit 60₁, 60₂, . . . , 60ₘ comprised in the voltage detecting unit 6 is dependent on the number of voltage detection performed for the illuminating unit that is to be coupled to the output channels (Ch1, Ch2), (Ch3, Ch4), . . . , (Ch(2n−1), Ch(2n)). For example, only one voltage detecting circuit 60₁, 60₂, . . . , 60ₘ may be arranged for any one of the two output channels (Ch1, Ch2), (Ch3, Ch4), (Ch(2n−1), Ch(2n)) of each of the current distributing circuits 20₁, 20₂, . . . , 20ₙ, i.e., totally n voltage detecting circuits are arranged, i.e., k=n. Similarly, in order to ensure more reliably that the voltage on the two terminals of the illuminating unit does not exceed the predetermined threshold according to the voltage detected on the two terminals of the illuminating unit, it is possible to arrange one voltage detecting circuit 60₁, 60₂, . . . , 60ₖ respectively for two output channels (Ch1, Ch2), (Ch3, Ch4), (Ch(2n−1), Ch(2n)) of each of the current distributing circuits 20₁, 20₂, . . . , 20ₙ, in this case k=2n, i.e., totally 2n voltage detecting circuits. In other words, the maximum number of the voltage detecting circuit 60₁, 60₂, . . . , 60ₖ is twice of the number of the current distributing circuits 20₁, 20₂, . . . , 20ₙ. For the sake of clearness, the schematic diagram with 2n voltage detecting circuit 60₁, 60₂, . . . , 60ₖ is not illustrated. According to the practical requirements, it is possible to select the voltage of the illuminating unit coupled to the two output channels of one or more current distributing circuit and perform detection with the arranged voltage detecting circuit, which will not be described in detail.

It should be understood here that the predetermined threshold can be determined according to the practical application situation and the related art. For example, it can be set according to the experience value of those skilled in the art, or can be set through appropriate times of experiments or learning process.

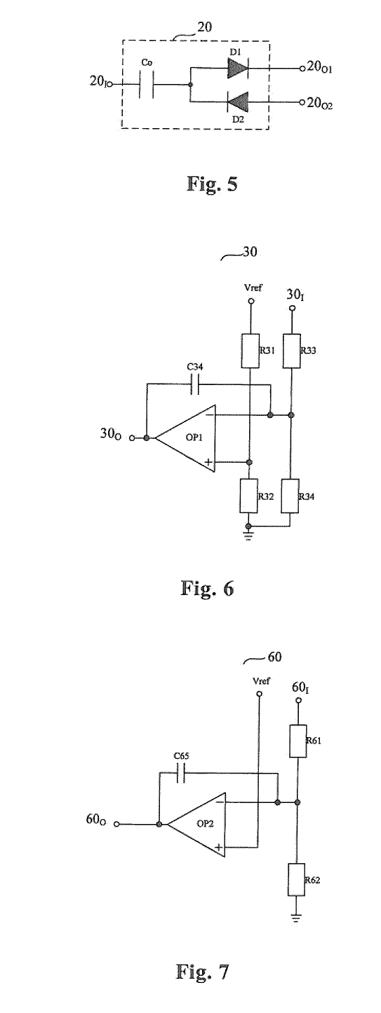

FIG. 5 shows a schematic diagram of the structure of the current distributing circuit in the multi-channel driver for driving the illuminating unit that can be used in each embodiment according to the disclosure. For the sake of conciseness, only the current distributing circuit in one of the current distributing units of the multi-channel driver is illustrated.

The current distributing circuit 20 comprises a capacitor Co and uni-direction conducting elements D1 and D2. The driving current provided by the power supply unit 1 (not shown) flows through the capacitor Co (from the input terminal 20₁ of the current distributing circuit 20) and is distributed to two output channels which are configured with one uni-direction conducting element D1 or D2 respectively, and the conducting direction of the uni-direction conducting elements D1 and D2 are directed so that the illuminating units (not shown) that are coupled respectively to the two output channels (here are coupled to the two output terminals 20_{O1} and 20_{O2} of the current distributing circuit 20) operate alternatively.

In other words, at least one current distributing circuit 20₁, 20₂, . . . , 20ₙ comprises respectively a capacitor Co and uni-direction conducting elements D1 and D2. The driving current flows through the capacitor Co and is distributed to two output channels (Ch1, Ch2), (Ch3, Ch4), (Ch(2n−1), Ch(2n)) which are configured with one uni-direction conducting element D1 or D2 respectively, and the conducting direction of the uni-direction conducting elements D1 and D2 are directed so that the illuminating units that are coupled respectively to the two output channels (Ch1, Ch2), (Ch3, Ch4), (Ch(2n−1), Ch(2n)) operate alternatively.

In a specific implementation, the uni-direction conducting element is a diode.

FIG. 6 shows a schematic diagram of the structure of the current detecting circuit in the multi-channel driver for driving the illuminating unit that can be used in each embodiment according to the disclosure. For the sake of conciseness, only one current detecting circuit of the multi-channel driver is illustrated.

Each of the at least one current detecting circuit 30₁, 30₂, . . . , 30ₘ of the current detecting unit 3 may be a comparator comprising an operational amplifier OP1. In the drawing, the current detecting circuit 30 comprises a comparator constituted by the operational amplifier OP1.

Specifically, the comparator may comprises a first operational amplifier OP1, a capacitor C34, a first reference voltage circuit, and a current collecting circuit for reflecting the current flowing through the illuminating unit (not shown) (i.e., the output current in the output channels (Ch1, Ch2), (Ch3, Ch4), (Ch(2n−1), Ch(2n))). The first reference voltage circuit provides the comparator with comparative reference voltage through a voltage divider constituted by the resistors R31 and R32 that is connected in series, the reference output terminal of the first reference voltage circuit is coupled to the positive input terminal of the first operational amplifier OP1. The current collecting circuit is formed by the series circuit con-stituted by the resistors R33 and R34. The series circuit converts the current that is input from the input terminal 30_{I} of the current detecting circuit 30 and flows through the illuminating unit into a voltage signal (voltage that is to be compared), and input the voltage signal to the negative input terminal of the first operational amplifier OP1, which is coupled to the output terminal 300 of the first operational amplifier OP1 through the capacitor C4. The first operational amplifier OP1 compares the reference output voltage provided by the first reference circuit with the voltage reflecting the detected current flowing through the illuminating unit (not shown), and output the comparison result to the control unit (not shown) through the output terminal 30ₒ thereof. Thus, the feedback circuit formed with the comparator realizes a constant output current in each output channel. In the subsequent embodiments, the operation process of the current detecting circuit will be described in detail in combination with the specific embodiments.

It should be understood by those skilled in the art, only the simplest implementing form of the comparator comprising the operational amplifier OP1 is illustrated here. According to the practical requirements, those skilled in the art can further add or remove various components (such as diode, transistor, etc.), adjust the parameter of the present components or modify the coupling relation among various components appropriately, so as to achieve the function of the above current detecting circuit.

FIG. 7 shows a schematic diagram of the structure of the voltage detecting circuit in the multi-channel driver for driving the illuminating unit that can be used in each embodiment according to the disclosure. For the sake of conciseness, only one voltage detecting circuit of the multi-channel driver is illustrated in FIG. 7.

Each of the at least one voltage detecting circuit 60₁, 60₂, . . . , 60ₖ of the voltage detecting unit 6 may be a comparator comprising an operational amplifier OP2. In the drawing, the voltage detecting circuit 60 comprises a comparator constituted by the operational amplifier OP2.

Specifically, the comparator may comprises a second operational amplifier OP2, a capacitor C65, and a voltage collecting circuit for detecting the voltage across the two terminals of the illuminating unit (not shown). The existing reference potential Vref in the multi-channel driver may be used as the comparing reference voltage for the positive output terminal of the second operational amplifier OP2, and the comparing reference voltage may be provided for the second operational amplifier OP2 through an appropriate voltage dividing circuit. The voltage collecting circuit is formed by the voltage dividing circuit constituted by the resistors R61 and R62. The voltage dividing circuit converts the voltage across the two terminals of the illuminating unit that is collected from the input terminal 60_{I} of the voltage detecting circuit 60 into a voltage value in an appropriate range, and inputs the voltage value to the negative input terminal of the second operational amplifier OP2, and couples it to the output terminal of the second operational amplifier OP2 through the capacitor C65. The second operational amplifier OP2 compares the reference voltage with the voltage value reflecting the voltage across the two terminals of the illuminating unit (not shown), and outputs the comparison result to the control unit (not shown) through the output terminal 60ₒ of the voltage detecting circuit. In the subsequent embodiments, the operation process of the voltage detecting circuit will be described in detail in combination with the specific embodiments.

It should be understood by those skilled in the art, only the simplest implementing form of the comparator comprising the operational amplifier OP2 is illustrated here. According to the practical requirements, those skilled in the art can further add or remove various components (such as diode, transistor, etc.), adjust the parameter of the present components or modify the coupling relation among various components appropriately, so as to achieve the function of the above voltage detecting circuit.

In a preferred embodiment, the multi-channel driver further comprises a plurality of capacitors C11, C12, . . . arranged in the output channels Ch1, Ch2, and these capacitors are used to smoothing the output in the corresponding output channel.

In another preferred embodiment, an optoelectric coupler is arranged between the control unit 4 and the current detecting unit 3, which is used to transfer the signal indicating the increase or decrease of the output current through the output channels (Ch1, Ch2), (Ch3, Ch4), (Ch(2n−1), Ch(2n)) to the control unit 4 in an optical manner. Thus, with the help of the optoelectric coupler, it can be avoided that the alternating current in the output channel interferes and affects the operation of the control unit 4, so that the operation of the multi-channel driver may be more stable and reliable.

In another preferred embodiment, the optoelectric coupler is arranged between the control unit 4 and the voltage detecting unit 6, which is used to transfer the signal indicating that the voltage across the two terminals of the illuminating unit exceeds a predetermined threshold to the control unit in an optical manner. Thus, with the help of the optoelectric coupler, it can be avoided that the interfering voltage (such as a spike voltage) in the output channel interferes the operation of the control unit 4, so that the operation of the multi-channel driver may be more stable and reliable.

Hereinafter, a specific example of the multi-channel driver for illuminating unit will be described according to an embodiment of the disclosure. It should be understood that the present disclosure will not be limited to the described specific embodiment due to the description of the drawings.

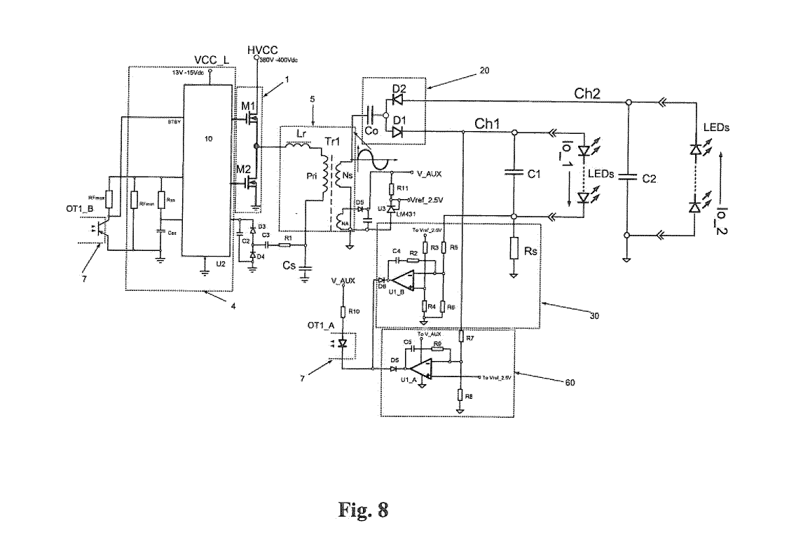

FIG. 8 shows a specific example of the multi-channel driver for driving the illuminating unit according to an embodiment of the present disclosure. Specifically, for the sake of conciseness, only a dual-channel driver is illustrated. However, it should be understood by those skilled in the art that the present disclosure is not limited to the dual-channel driver, but can increase the number of the channel arbitrary according to the practical requirements.

As shown in FIG. 8, the multi-channel driver comprises a power supply unit 1, a control unit 4, an input stage 5, a current distributing circuit 20, a current detecting unit 30, a voltage detecting unit GO and two output channels Ch1 and Ch2. The two control terminals of the control unit 4 are coupled to the gates (i.e., the control electrodes) of the two field effect transistors M1 and M2 that constitute the power supply unit 1. The two field effect transistors constitute a half-bridge circuit. The bridge middle point of the half-bridge circuit is coupled to the input terminal of the input stage 5, i.e., a terminal of the primary winding Lr of the transistor Tr1. Thus, the driving current provided by the power supply unit 1 is coupled to the current distributing circuit 20 through the input stage. In other words, the energy is provided to the current distributing circuit 20 through the electric-magnetic coupling between the primary winding Lr and the secondary winding Ns of the transistor Tr1. The current distributing circuit 20 distributes the driving current to two output channels Ch1 and Ch2, i.e., provides the illuminating unit (here are a plurality of LEDs) coupled to the output channels Ch1 and Ch2 respectively with the output currents Io_{—}1 and Io_2.

In the specific example, capacitors C1 and C2 are connected parallel to the two terminals of the illuminating unit coupled to the output channels Ch1 and Ch2, so as to smooth the output currents of the channels Ch1 and Ch2.

The current detecting circuit 30 detects the output current in the output channel with the help of the shunting function of the resistor Rs connected in series after the illuminating unit in the output channel Ch1 (i.e., the current flowing through the LED), converts the output current into a voltage signal through the series circuit constituted by the resistors R5 and R6 connected in series, and compares the voltage signal with the com-parative reference voltage through the comparator comprising the operational amplifier U1_B. Meanwhile, the comparison result is provided to the control unit 4 through the optoelectric coupler 7. Thus, a feedback loop is formed.

Similarly, the voltage detecting unit 60 is connected in parallel between the two terminals of the illuminating unit (i.e., a plurality of LEDs), so as to obtain the voltage across the two terminals of the illuminating unit, which is compared with the reference voltage through the comparator comprising the operational amplifier U1_A. The comparison result from the comparator is provided to the control unit 4 through the same optoelectric coupler 7. Thus, a feedback control of the voltage across the two terminals of the illuminating unit is formed.

The control unit 4 adjusts the driving current provided by the power supply unit 1 according to the output current of the output channel Ch1 detected by the current detecting circuit 30, i.e., the current Io_{—}1 flowing through the illuminating unit (here are a plurality of LEDs) coupled in the output channel Ch1, or according to the voltage Uo_1 across the two terminals of the LED detected by the voltage detecting circuit 60, so that the output current in the output channel Ch1 is maintained constant and the voltage across the two terminals of the illuminating unit does not exceed the predetermined threshold. Due to the characteristic of balanced charging and discharging of the capacitor Co, when the output current in the output channel Ch1 is maintained constant or when the voltage across the two terminals of the illuminating unit coupled in the output channel Ch1 does not exceed the predetermined threshold, the output current in the output channel Ch2 is maintained constant and the voltage across the two terminals of the illuminating unit coupled in the output channel Ch2 does not exceed the predetermined threshold. In other words, due to the characteristic of the capacitor Co, i.e., the number of the electron during the charging and discharging of the capacitor is constant, there is a balance between the output currents of the two output channels Ch1 and Ch2.

The control unit 1 may comprise a micro controller 10. As for the present example, the micro controller 10 with the type of L6599 is used as the main component of the control unit 1. The micro controller controls the driving current output by the half-bridge circuit constituting the power supply unit 1 according to the detecting signal provided by the current detecting circuit and the voltage detecting circuit.

It should be understood by those skilled in the art that the micro controller 10 is not limited to the type and category of the micro controller used here. Meanwhile, the type, number and cou-pling relation of other peripheral devices in the control unit is not limited to the type, number and coupling relation shown. Instead, the relevant peripheral devices may be added or removed, the type and the modulation coupling relation may be changed arbitrary according to the practical requirements.

A plurality of illuminating unit is coupled in each output channels of the multi-channel driver. In particular, here is the LED. In the present disclosure, it is not excluded that other illuminating unit of other type may be employed such as fluorescent lamp or incandescent lamp. Capacitors CI and C2 are connected in parallel between the two terminals of each illuminating unit, so as to smooth the output current in the output channels Ch1 and Ch2.

The input stage 5 is transistor Tr1. Certainly, the present disclosure is not limited to the transformer or the transformer structure shown here. Instead, it may be other component that can realize the voltage coupling or current coupling, or may be the transformer structure that modulates the operating characteristic of the input stage 5 by adding corresponding components. In the present embodiment, the transistor Tr1 further provides the operational amplifier and optoelectric coupler used with reference voltage or operating voltage.

The current detecting unit 30 and the voltage detecting unit 60 provide the control unit 4 with the comparison result of each comparator through the optoelectric coupler 7 (OT1_A and OT1_B). On the output terminal of the current detecting unit 30 and the voltage detecting unit 60, there is arranged a uni-direction conducting element (here is a diode), which is adapted to prevent the interference between the current detecting unit 30 and the voltage detecting unit 60. The sinus current is taken as an example here to describe the operation of the multi-channel driver for driving the illuminating unit according to an embodiment of the present disclosure. However, the present disclosure does not exclude using other type of driving current such as the alternative symmetric serrasoid wave, alternative symmetric square wave, etc.

During the operation of the multi-channel driver, due to the affection of various factors, the output current in each output channel may fluctuate. The control unit performs adjustment according to the current detecting unit 30 and the voltage detecting unit 60, so that the output current in the individual output channels is maintained constant, and it is avoided that the voltage on the illuminating unit to be coupled exceeds the predetermined threshold. If the current Io_1 output through the output channel Ch1 is increased, it may cause the voltage V_Rs on the resistor Rs connected in series after the LED in the output channel Ch1 to increase, thus the output voltage Vo_U1_B of the operational amplifier U1_B in the current detecting unit 30 is caused to increase, and further the current Id_OT1_A flowing through the optoelectric component OT1_A is caused to increase, and finally the control unit 4 receives the detecting signal through the opto-coupling of the optoelectric component OT1_A and the optoelectric component OT1_B, and thus the control unit causes the switching frequency of the half-bridge circuit constituted by the field effect transistor M1 and M2 to increase. As a result, the voltage drop Vdrop_Lr applied to the primary winding Lr of the input stage 5 is increased, and the output voltage Vo_Tr1_Ns on the secondary winding thereof is decreased, and thus the voltage Vo_C1 on the capacitor C1 coupled to the output channel Ch1 of the current distributing circuit is decreased, and finally the Io_1 is decreased. Thus, the output current of the output channel is maintained constant.

During the operation of the multi-channel driver, if the current Io_{—}1 output through the output channel Ch1 is decreased, the voltage V_Rs on the resistor Rs connected in series after the LED in the output channel Ch1 will be decreased, so that the output voltage Vo_U1_B of the operational amplifier U1_B in the current detecting circuit 30 will be increased, and the current Id_OT1_A flowing through the optoelectric component OT1_A will be decreased, and finally the control unit 4 receives the detecting signal through the opto-coupling of the optoelectric component OT1_A and the optoelectric component OT1_B, thus the control unit 4 decreases the switching frequency of the half-bridge constituted by the field effect transistor M1 and M2. As a result, the voltage drop Vdrop_Lr applied on the secondary winding Lr of the input stage 5 is decreased, and thus the output voltage Vo_Tr1_Ns on the secondary winding is increased, so that the voltage Vo_C1 on the capacitor CI coupled to the output channel Ch1 of the current distributing circuit 20 is increased, and finally the Io_1 is increased. Thus, the output current of the output channel is maintained constant.

When the voltage detecting unit 60 detects that the voltage is higher than the predetermined threshold, the voltage detecting unit 60 detects this change and cause the output voltage Vo_U1_A of the operational amplifier U1_A of the voltage detecting unit 60 to be decreased, and the current Id_OT1_A flowing through the optoelectric component OT1_A will be increased, and the control unit 4 receives the detecting signal through the opto-coupling of the optoelectric component OT1_A and the optoelectric component OT1_B. Thus, the control unit 4 increases the switching frequency of the half-bridge circuit constituted by the field effect transistor M1 and M2. As a result, the voltage drop Vdrop_Lr applied on the primary winding Lr of the input stage 5 is increased, and thus the output voltage Vo_Tr1_Ns on the secondary winding is decreased, so that the voltage Vo_C1 on the capacitor CI coupled to the output channel Ch1 of the current distributing circuit 20 is decreased, and finally the voltage Io_1 on the illuminating unit is decreased.

The adjustment of the output channel Ch1 that is not coupled to the current detecting circuit and the voltage detecting circuit may be achieved with the characteristic of the capacitor Co. The capacitor Co has two functions as follows: first, transferring the energy from the transformer Tr1 to the load (LED), and second, balancing the output currents of the output channels Ch1 and Ch2, which is achieved through the characteristic of the capacitor that the number of the electron during the charging and discharging should be the same. In the multi-channel driver according to the embodiment of the present disclosure, when the output Io_1 of the output channel Ch1 is increased, the capaci-tor Co causes the current I_D1 of the diode D1 in the output channel Ch1 to be increased, and further causes the number of the charge q_Co to be increased during the charging. As a result, it causes the voltage V_Co of the capacitor Co to be increased, and causes the number of the charge q_Co to be increased during the discharging, and finally the output current Io_2 in the output channel Ch2 is increased. Thus, it is achieved the balance between the two output channels Ch1 and Ch2. It is ensured that the operation current for the illuminating unit flowing in the two output channels Ch1 and Ch2 are the same. It is easy to be understood that if no capacitor Co is arranged, it is possible to achieve the stability of the output current in the output channel Ch2 and the driving voltage across the two terminals of the illuminating unit driven by the output channel through arranging similar current detecting unit and voltage detecting unit in the output channel Ch2 as that in the output channel Ch1 and performing feedback control. If the standard values for the voltage and current feedback control of the two channels are set to be the same, it can be ensured that the output currents and driving voltages of the two channels are the same. Certainly, if the capacitor Co and current detecting unit and voltage detecting unit are arranged simultaneously for the current distributing unit, besides the advantage of ensuring the stability of the current and driving voltage in each output channel, additional advantages can be obtained, i.e., the operating stability of the multi-channel driver is improved. Thus, in the multi-channel driver according to the above embodiments, the number of the current detecting unit and voltage detecting unit can be set according to practical situation, as long as the output current and driving voltage of each channel for driving the illuminating unit is stable and controllable. For example, it is possible to arrange corresponding current detecting unit and voltage detecting unit for each current distributing circuit, or it is possible to arrange corresponding current detecting unit and voltage detecting unit for a specific current distributing circuit. For example, in the case that the capacitor Co is used to achieve the balance of the output channel of each channel, it is not necessary to arrange a corresponding current detecting unit and voltage detecting unit for each current distributing circuit, thus the circuit structure is simplified. The multi-channel driver has a simple structure. Due to the simple structure, the fabrication cost thereof is low. Further, the multi-channel driver reduces the additional power consumption, and thus has a high efficiency.

Moreover, the present disclosure provides an illuminating device, which comprises the multi-channel driver and illuminating unit as described in one of the above embodiments, as shown in FIG. 8. The illuminating unit is coupled to the output channel of the multi-channel driver, and obtains the operating current from the multi-channel driver. Further, the illuminating unit is an LED. Finally, it should be noted that the term “include”, “comprise” or any other variations means a non-exclusive inclusion, so that the process, method, article or device that includes a series of elements includes not only these elements but also other elements that are not explicitly listed, or further includes inherent elements of the process, method, article or device. Moreover, when there is no further limitation, the element defined by the wording “include (s) a . . . ” does not exclude the case that in the process, method, article or device that includes the element there are other same elements.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

1. A multi-channel driver for driving an illuminating unit, comprising: a plurality of output channels for coupling with the illuminating unit;
a power supply unit for supplying a driving current;
a current distributing unit, which comprises at least one current distributing circuit, wherein the at least one current distributing circuit comprises two output channels respectively, and distributes the driving current provided by the power supply unit to the two output channels;
a current detecting unit for detecting the output current output by the output channels, wherein the current detecting unit is configured with at least one current detecting circuit for the two output channels of the at least one current distributing circuit, and
a control unit, wherein the control unit regulates the driving current provided by the power supply unit according to the output current detected by the at least one current detecting circuit of the current detecting unit, so that the output current in the output channels is maintained constant.

2. The multi-channel driver according to claim 1, further comprising: an input stage, wherein the input stage is arranged in series between the power supply unit and the current distributing unit, and is adapted to convert the driving current provided by the power supply unit to one or more input current for the current distributing unit.

3. The multi-channel driver according to claim 1, further comprising: a voltage detecting unit, wherein the voltage detecting unit is configured with at least one voltage detecting circuit for the two output channels of the at least one current distributing circuit, wherein the control unit regulates the driving current supplied by the power supply unit according to the voltage on two terminals of the illuminating unit detected by the at least one voltage detecting circuit of the voltage detecting unit, so that the voltage on two terminals of the illuminating unit is maintained to not exceed a predetermined threshold.

4. The multi-channel driver according to claim 1, wherein the at least one current distributing circuit comprises respectively a capacitor and uni-direction conducting elements, the driving current flows through the capacitor and is distributed to two output channels which are configured with one uni-direction conducting element respectively, and the conducting direction of the uni-direction conducting elements are directed so that the illuminating units that are coupled respectively to the two output channels operate alternatively.

5. The multi-channel driver according to claim 2, wherein the input stage may comprise a transformer, wherein the transformer comprises a primary winding and a plurality of secondary windings, and the number of the secondary windings equals to the number of the at least one current distributing circuit, wherein each of the secondary windings is coupled to the input terminal of one of the at least one current distributing circuits.

6. The multi-channel driver according to claim 1, wherein the at least one current detecting circuit of the current detecting unit may be a comparator comprising an operational amplifier.

7. The multi-channel driver according to claim 3, wherein the at least one voltage detecting circuit of the voltage detecting unit may be a comparator comprising an operational amplifier.

8. The multi-channel driver according to claim 1, further comprising: a plurality of capacitors arranged in the output channels, wherein these capacitors are used to smooth the output current.

9. The multi-channel driver according to claim 1, wherein an optoelectric coupler is arranged between the control unit and the current detecting unit, which is used to transfer the signal indicating the increase or decrease of the output current through the output channels to the control unit in an optical manner.

10. The multi-channel driver according to claim 3, wherein the optoelectric coupler is arranged between the control unit and the voltage detecting unit, which is used to transfer the signal indicating that the voltage across the two terminals of the illuminating unit exceeds a predetermined threshold to the control unit in an optical manner.

11. The multi-channel driver according to claim 4, wherein the uni-direction conducting elements are diodes.

12. An illuminating device, comprising a multi-channel driver
the multi-channel driver comprising:
a plurality of output channels for coupling with the illuminating unit;
a power supply unit for supplying a driving current;
a current distributing unit, which comprises at least one current distributing circuit, wherein the at least one current distributing circuit comprises two output channels respectively, and distributes the driving current provided by the power supply unit to the two output channels;
a current detecting unit for detecting the output current output by the output channels, wherein the current detecting unit is configured with at least one current detecting circuit for the two output channels of the at least one current distributing circuit, and
a control unit, wherein the control unit regulates the driving current provided by the power supply unit according to the output current detected by the at least one current detecting circuit of the current detecting unit, so that the output current in the output channels is maintained constant, and
an illuminating unit,
wherein the illuminating unit is coupled to the output channel of the multi-channel driver, and obtains the operating current from the multi-channel driver.

13. The illuminating device according to claim 12, wherein the illuminating unit is diode.
